(19) United States
(12) Patent Application Publication
(10) Pub. No.: US 2015/0366741 A1
(43) Pub. Date: Dec. 24, 2015

(54) SUSPENDED BABY WALKER

(71) Applicant: James Ropes, Ray Township, MI (US)

(72) Inventor: James Ropes, Ray Township, MI (US)

(21) Appl. No.: 14/311,251

(22) Filed: Jun. 21, 2014

(51) Int. Cl. A61H 3/00

(52) U.S. Cl. CPC A61H 3/008

(57) ABSTRACT

A suspended baby walker for attaching to a ceiling and allowing vertical and restricted horizontal movement along a suspended track comprises a seat assembly defined as a conventional baby jumper seat, a suspension assembly having a pole portion a suspension connector, and a jumper rope, a mounting assembly defined by a strap connector, a mounting strap and a mounting bracket, and a mounting track which is attached to the ceiling. The seat assembly is rollably attached to the mounting track through the connection of the seat assembly to the suspension assembly, the suspension assembly to the mounting assembly, and the mounting assembly to the mounting track. In operation, a child disposed in the seat assembly can move the seat assembly horizontally back and forth along the length of the mounting track and can jump vertically without placing excess stress on the components due to the elastic nature of the jumper rope.

### BACKGROUND OF THE INVENTION

1. Field of the Invention

This invention relates generally to baby devices and, more particularly, to a baby walker which is suspended from and movably disposed a channel track in the ceiling.

2. Description of the Prior Art

The use of baby walkers in assisting a baby and small children to develop the motor skills necessary to perform the physical movements necessary to stand, walk and run is well known. Common methods of teaching children such upright movements without walkers often requires the continual provision of manual assistance; i.e. parents and/or supervisors holding up the child to provide stability while the child attempts to stand, walk and/or run. Consequently, a problem which still exists is that children learning the mechanics of such basic upright movements with manual assistance or in walkers are often prone to injuries caused by slipping and falling on hard surfaces or falling down stairs or steps. Thus, there remains a need for a suspended baby walker which would not require effective coordination or grip of a supervisor to reduce the risk the possibility of a child falling while learning basic upright movement skills. It would be helpful if such a suspended baby walker eliminated the possibility of a child falling down steps while learning basic upright movements. It would be additionally desirable for such a suspended baby walker to be structured to be deployed in a plurality of indoor environments.

The Applicant's invention described herein provides for a suspended baby walker adapted to attach to a ceiling and allow restricted movement along a suspended track. The primary components in Applicant's suspended baby walker are a seat assembly, a mounting track, a mounting assembly, and a suspension assembly. When in operation, the suspended baby walker enables placement of a child therein for practicing upright movements. As a result, many of the limitations imposed by prior art structures are removed.

### SUMMARY OF THE INVENTION

A suspended baby walker for attaching to a ceiling and allowing vertical and restricted horizontal movement along a suspended track. The suspended baby walker comprises a seat assembly defined as a conventional baby jumper seat, a suspension assembly having a pole portion a suspension connector, and a jumper rope, a mounting assembly defined by a strap connector, a mounting strap and a mounting bracket, and a mounting track which is attached to the ceiling. The seat assembly is rollably attached to the mounting track through the connection of the seat assembly to the suspension assembly, the suspension assembly to the mounting assembly, and the mounting assembly to the mounting track.

In operation, a child disposed in the seat assembly can move the seat assembly horizontally back and forth along the length of the mounting track and can jump vertically without placing excess stress on the components due to the elastic nature of the jumper rope. Through such action, the suspended baby walker allows controlled horizontal and vertical movement by a child, while still preventing the child from falling due to its suspended nature or from wandering beyond the area along the mounting track.

It is an object of this invention to provide a suspended baby walker which would not require effective coordination or grip of a supervisor to reduce the risk the possibility of a child falling while learning basic upright movement skills.

It is another object of this invention to provide a suspended baby walker which eliminated the possibility of a child falling down steps while learning basic upright movements.

It is yet another object of this invention to provide a suspended baby walker structured to be deployed in a plurality of indoor environments.

These and other objects will be apparent to one of skill in the art.

### BRIEF DESCRIPTION OF THE DRAWINGS

FIG. 1 is a front perspective view of a suspended baby walker built in accordance with the present invention.

FIG. 2 is a side perspective view of a suspended baby walker built in accordance with the present invention.

FIG. 3 is a side elevational view of the mounting bracket of a suspended baby walker built in accordance with the present invention.

### DETAILED DESCRIPTION OF THE INVENTION

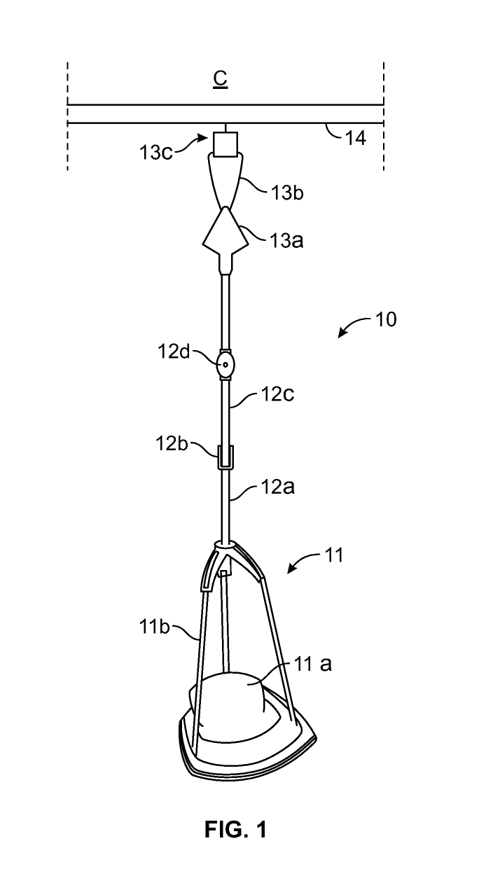

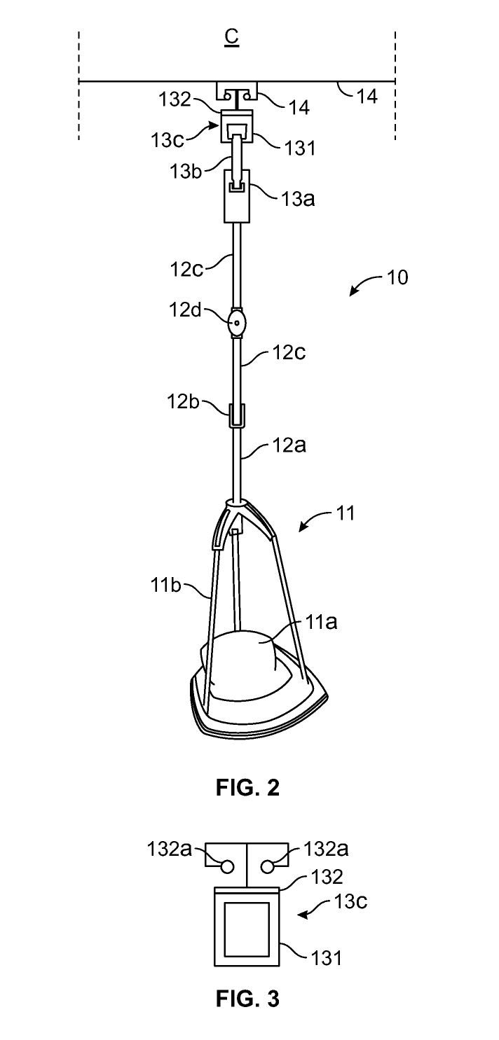

Referring now to the drawings and in particular FIGS. 1 through 3, a suspended baby walker 10 is shown having a seat assembly 11, a suspension assembly 12, a mounting assembly 13, and a mounting track 14. The seat assembly 11 is defined as a conventional baby jumper seat 11a structure which includes a vertically extending mounting frame 11b attached thereto. The seat assembly 11 provides a means for retaining a child in the suspended baby walker 10.

The suspension assembly 12 includes a pole portion 12a a suspension connector 12b, and a jumper rope 12c. The mounting assembly 13 is defined by a strap connector 13a, a mounting strap 13b and a mounting bracket 13c. Together, the suspension assembly 12 and the mounting assembly 13 provide a means for suspending the seat assembly 10.

In the preferred embodiment, the pole portion 12a is an elongated, rigid pole attached at one end to the mounting frame 11b of the seat assembly 11 and at the other end to the suspension connector 12b. The suspension connector 12b joins the pole portion 12a with the jumper rope 12c. The jumper rope 12c is an elongated, elastic rope having an adjustment piece 12d and which connects the seat assembly 11 and suspension assembly 12 to the mounting assembly 13 through its connection to the strap connector 13a. The adjustment piece 12d is disposed on the jumper rope 12c and enables the length of the jumper rope 12c to be adjusted in the same manner as a conventional cam buckle. The elastic nature of the jumper rope 12c absorbs any shock generated by a child in the seat assembly 11 jumping, and thus enables the suspended baby walker 10 to withstand jumping or other movement from a child without placing excess stress on the ceiling C, the seat assembly 11, the mounting assembly 13 or the mounting track 14.

The mounting strap 13b forms a continuous loop which passes at one end through the strap connector 13a and on the other end through the mounting bracket 13c. The mounting strap 13 slidably passes through a hollow channel in the strap connector 13a and a hollow channel in the mounting bracket 13c; it is therefore understood that it will maintain the seat assembly 11 at a balanced level in the event the mounting strap 13 is knocked off center during use or if the mounting track 14 is attached to a slanted ceiling. In the preferred embodiment, the mounting strap 13b is constructed of a flexible material.

The mounting bracket 13c includes a strap portion 131 and an attachment portion 132. The strap portion 131 includes the hollow channel for the mounting strap to pass through and the attachment portion 132 includes two wheels 132a which enable the attachment portion 132 to roll when placed on the mounting track 14.

The mounting track 14 is attached to a ceiling C and receives the attachment portion 132 of the mounting bracket 13c. The wheels 132a enable the mounting bracket 13c to roll along the length of the mounting track 14. In this regard, a child disposed in the seat assembly 11 can move the seat assembly horizontally back and forth along the length of the mounting track 14, but no further than that. As such, the suspended baby walker 10 allows controlled horizontal and vertical movement by a child, but prevents the child from falling due to its suspended nature or from wandering beyond the area along the mounting track 14.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. A suspended baby walker, comprising:
a seat assembly;
a suspension assembly attached to said seat assembly; and
a mounting frame attached to a fixed structure, wherein said suspension assembly is movably connected to said mounting frame.

2. The suspended baby walker of claim 1, wherein said fixed structure is a ceiling.

3. The suspended baby walker of claim 2, wherein said suspension assembly includes an elastic jumper rope.

4. The suspended baby walker of claim 2, wherein, said suspension assembly is adjustable in length.

5. The suspended baby walker of claim 2, wherein said suspension assembly is connected to said mounting frame through a mounting assembly.

6. The suspended baby walker of claim 5, wherein said mounting track is defined by an elongated track.

7. The suspended baby walker of claim 6, wherein said mounting assembly includes an attachment portion rollably disposed in said mounting track.

8. The suspended baby walker of claim 5, wherein said mounting assembly is adapted to maintain the seat assembly at a balanced level.

9. A suspended baby walker, comprising:
a means for retaining a child;
a means for suspending said means for retaining; and
a mounting frame attached to a fixed structure, wherein said means for suspending is movably connected to said mounting frame.
